(19) United States
(12) Patent Application Publication
(10) Pub. No.: US 2024/0002578 A1
(43) Pub. Date: Jan. 4, 2024

(54) A POLYURETHANE FOAM COMPOSITION COMPRISING AN AROMATIC POLYESTER POLYOL COMPOUND AND PRODUCTS MADE THEREFROM

(71) Applicant: Huntsman International LLC, The Woodlands, TX (US)

(72) Inventors: Kai XI, The Woodlands, TX (US); Paul MACKEY, The Woodlands, TX (US); Lifeng WU, The Woodlands, TX (US); Sachchida SINGH, The Woodlands, TX (US)

(21) Appl. No.: 18/039,319

(22) PCT Filed: Dec. 3, 2021
(86) PCT No.: PCT/US2021/061785

§ 371 Date: May 30, 2023

Related U.S. Application Data
(60) Provisional application No. 63/120,993, filed on Dec. 3, 2020.

(51) Int. Cl. C08G 18/36; C08G 18/32; C08G 18/34; C08G 18/76; C08J 9/14

(52) U.S. Cl. CPC C08G 18/36; C08G 18/3206; C08G 18/348; C08J 2375/04; C08G 18/7664; C08J 9/144; C08J 2203/144; C08G 18/341

(57) ABSTRACT

A polyurethane foam composition comprising: (a) an isocyanate compound; (b) one or more isocyanate reactive compounds and wherein at least one of the isocyanate reactive compounds comprises an aromatic polyester polyol compound that is the reaction product of: (i) an aromatic acid compound; (ii) an aliphatic diol compound; (iii) a dialkylol alkanoic acid compound; and (iv) optionally, a polyhydroxy compound comprising at least three hydroxyl groups, a hydrophobic compound, or combinations thereof; and wherein the aromatic polyester polyol compound is liquid at 25° C. and has a hydroxy value ranging from 30 to 600; and (c) a blowing agent.

### CROSS-REFERENCE TO RELATED APPLICATIONS

This application claims priority to U.S. Provisional Application No. 63/120,993 filed Dec. 3, 2020. The noted application(s) are incorporated herein by reference.

### BACKGROUND

### Field

The present disclosure relates generally to a polyurethane foam composition comprising an aromatic polyester polyol compound and products made therefrom.

### Background Information

Polyurethane (“PU”) and polyisocyanurate (“PIR”) based foam products are widely used in the building construction industry because of their superior sealing and insulative properties when compared to other building insulation solutions used in the industry.

Materials used in the construction of a building, such as the PU and/or PIR based foam products, must have very good mechanical properties, such as compressive strength to withstand construction activities, such as foot/wheel-barrow traffic on roof or lifting by crane for wall. Such foam products also need to have good dimensional stability under full range of weather, ranging from very low temperature to hot/humid conditions. Raising the density of the foam used is one way to improve compressive strength and dimensional stability but that increases its environmental burden and cost. Thus, it is desirable to develop PU and/or PIR based foam products with improved compressive strength and dimensional stability at low foam density.

### DETAILED DESCRIPTION

As used herein, unless otherwise expressly specified, all numbers such as those expressing values, ranges, amounts or percentages may be read as if prefaced by the word “about”, even if the term does not expressly appear. Plural encompasses singular and vice versa.

As used herein, “plurality” means two or more while the term “number” means one or an integer greater than one.

As used herein, “includes” and like terms means “including without limitation.”

When referring to any numerical range of values, such ranges are understood to include each number and/or fraction between the stated range minimum and maximum. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “molecular weight” means weight average molecular weight (M_{w}) as determined by Gel Permeation Chromatography.

Unless otherwise stated herein, reference to any compounds shall also include any isomers (e.g., stereoisomers) of such compounds.

As used herein, “isocyanate index” or “NCO index” is the molar ratio of isocyanate groups over isocyanate reactive hydrogen atoms present in a composition given as a percentage:

$$\frac{[ NCO ] \times 100}{[ active hydrogen ]} ( \% )$$

It should be noted that the NCO index expresses the percentage of isocyanate used in a composition with respect to the amount of isocyanate theoretically required for reacting with the amount of isocyanate-reactive hydrogen in the composition during the polymerization stage. Any isocyanate groups consumed in a preliminary step to produce a modified polyisocyanate compound (e.g., pre-polymer) or any active hydrogens consumed in a preliminary step (e.g., reacted with isocyanate to produce modified polyols or polyamines) are not considered in the calculation of the NCO index. Only the free isocyanate groups and the free isocyanate reactive hydrogens (including those of water, if used) present at the actual polymerization stage are considered in the calculation of the NCO index.

For purposes of calculating the NCO index, the expression “isocyanate reactive hydrogen atoms” refers to the total active hydrogen atoms in hydroxyl and amine functional groups present in the composition. In other words, at the polymerization stage, one hydroxyl group is deemed to comprise one reactive hydrogen; one primary amine group is deemed to comprise one reactive hydrogen; and one water molecule is deemed to comprise two active hydrogens.

As used herein, “liquid” means having a viscosity of less than 200 Pa·s. as measured according to ASTM D445-1 1a at 20° C.

As used herein, “trimerization catalyst” means a catalyst that catalyzes (promotes) the formation of isocyanurate groups from isocyanates.

### Polyurethane/Polyisocyanurate Foam Composition

PU and PIR foam products are used in a variety of applications such as building construction, transportation, pipeline, shipbuilding, sporting goods, furniture, and packaging. The widespread use of such foam products over numerous industries can be attributed to the fact that these products can be formulated to have a wide range of properties.

For example, in building construction applications, low density (e.g., 0.5-4 pcf) PU and PIR foams are used as insulation in sandwich or construction panels (e.g., panels used in roofs, walls, ceilings, and floors) or as spray-in-place foam because of their: (i) robust insulative/sealing performance; (ii) ability to meet or exceed building codes related to flammability and heat resistance/retardancy; and (iii) ability to enhance a structure's structural integrity even if the structure is subjected to intense heat.

Similarly, low density (e.g., 1.5-4 pcf) PU and PIR foams are also used as insulation in transportation, pipeline, and shipbuilding applications. For example, these foam products are widely used in refrigerated vehicles, district heating systems (e.g., pipelines used to transport steam or hot water), and industrial pipelines or storage tanks used in the transport and storage of oil and other hydrocarbons.

In contrast to low density PU and PIR foams, high density PU and PIR foams are often used in non-insulative applications such as vehicular interior trim and headliners, office furniture, molded chair shells, simulated wood furnishing, and rigid molding.

As stated above, the PU and PIR foam products must have good mechanical properties such as compressive strength and good dimensional stability. The polyurethane foam composition of the present disclosure allows a formulator to make such foam at foam densities nominally practiced in the industry.

The polyurethane foam composition disclosed herein comprises: (A) an isocyanate compound; (B) one or more isocyanate reactive compounds at least one of the isocyanate reactive compounds comprises an Aromatic Polyester Polyol Compound (defined below) wherein the Aromatic Polyester Polyol Compound is the reaction product of: (i) an aromatic acid compound; (ii) an aliphatic diol compound; (iii) a dialkylol alkanoic acid compound of Formula I (shown below); and (iv) optionally, a polyhydroxy compound comprising at least three hydroxyl groups, a hydrophobic compound, or combinations thereof; and wherein the Aromatic Polyester Polyol Compound is liquid at 25° C. and has a hydroxy value ranging from 30 to 600.

### Isocyanate Compound

The polyurethane foam composition disclosed herein comprises one or more isocyanate compounds. In some embodiments, the isocyanate compound is a polyisocyanate compound. Suitable polyisocyanate compounds that may be used include aliphatic, araliphatic, and/or aromatic polyisocyanates. The isocyanate compounds typically have the structure R—(NCO)ₓ where x is at least 2 and R comprises an aromatic, aliphatic, or combined aromatic/aliphatic group. Non-limiting examples of suitable polyisocyanates include diphenylmethane diisocyanate (“MDI”) type isocyanates (e.g., 2,4′, 2,2′, 4,4′MDI or mixtures thereof), mixtures of MDI and oligomers thereof (e.g., polymeric MDI or “crude” MDI), and the reaction products of polyisocyanates with components containing isocyanate-reactive hydrogen atoms (e.g., polymeric polyisocyanates or prepolymers). Accordingly, suitable isocyanate compounds that may be used include SUPRASEC® DNR isocyanate, SUPRASEC® 2185 isocyanate, RUBINATE® M isocyanate, and RUBINATE® 1840 isocyanate, or combinations thereof. SUPRASEC® and RUBINATE® isocyanates are all available from Huntsman Corporation.

Other examples of suitable isocyanate compounds also include tolylene diisocyanate (“TDI”) (e.g., 2,4 TDI, 2,6 TDI, or combinations thereof), hexamethylene diisocyanate (“HMDI” or “HDI”), isophorone diisocyanate (“IPDI”), butylene diisocyanate, trimethylhexamethylene diisocyanate, di(isocyanatocyclohexyl)methane (e.g., 4,4′-diisocyanatodicyclohexylmethane), isocyanatomethyl-1,8-octane diisocyanate, tetramethylxylene diisocyanate (“TMXDI”), 1,5-naphtalenediisocyanate (“NDI”), p-phenylenediisocyanate (“PPDI”), 1,4-cyclohexanediisocyanate (“CDI”), tolidine diisocyanate (“TODI”), or combinations thereof. Modified polyisocyanates containing isocyanurate, carbodiimide or uretonimine groups may also be employed as Component (1).

Blocked polyisocyanates can also be used as Component (1) provided that the reaction product has a deblocking temperature below the temperature at which Component (1) will be reacted with Component (2). Suitable blocked polyisocyanates can include the reaction product of: (a) a phenol or an oxime compound and a polyisocyanate, or (b) a polyisocyanate with an acid compound such as benzyl chloride, hydrochloric acid, thionyl chloride or combinations. In certain embodiments, the polyisocyanate may be blocked prior to introduction into the reactive ingredients/components used to in the composition disclosed herein.

Mixtures of isocyanates, for example, a mixture of TDI isomers (e.g., mixtures of 2,4- and 2,6-TDI isomers) or mixtures of di- and higher polyisocyanates produced by phosgenation of aniline/formaldehyde condensates may also be used as Component (1).

In some embodiments, the isocyanate compound is liquid at room temperature. A mixture of isocyanate compounds may be produced in accordance with any technique known in the art. The isomer content of the diphenyl-methane diisocyanate may be brought within the required ranges, if necessary, by techniques that are well known in the art. For example, one technique for changing isomer content is to add monomeric MDI (e.g., 2,4-MDI) to a mixture of MDI containing an amount of polymeric MDI (e.g., MDI comprising 30% to 80% w/w 4,4-MDI and the remainder of the MDI comprising MDI oligomers and MDI homologues) that is higher than desired.

In some embodiments, the isocyanate compound comprises 30% to 65% (e.g., 33% to 62% or 35% to 60%) by weight of the total polyurethane foam composition.

### Isocyanate Reactive Compound

The polyurethane foam composition disclosed herein comprises one or more isocyanate reactive compounds. As stated above, at least one of the isocyanate reactive compounds used in the polyurethane foam composition comprises an aromatic polyester polyol compound (“Aromatic Polyester Polyol Compound”). Any of the known organic compounds containing at least two isocyanate reactive moieties per molecule may be employed as the other isocyanate reactive compound in the polyurethane foam composition (“Other Polyol Compound”).

In some embodiments, the isocyanate reactive compound comprises 20% to 50% (e.g., 23% to 47% or 25% to 45%) by weight of the polyurethane foam composition.

Aromatic Polyester Polyol Compound

The Aromatic Polyester Polyol Compound of the present disclosure exhibits compatibility with components that are typically used in PU and PIR foam compositions such as hydrocarbon blowing agents (e.g., pentane, HFC based blowing agents) while having low viscosity, high functionality, and high aromatic content properties.

In certain embodiments, the Aromatic Polyester Polyol Compound has a calculated number average functionality ranging from 1.7 to 4 (e.g., 2 to 3.5 or 2.2 to 3) and an average hydroxyl number ranging from 30 to 600 (e.g., 50 to 500 or 100 to 450). It is noted that the hydroxyl number does take into account that free glycols may be present. The hydroxyl number of the Aromatic Polyester Polyol Compound can be measured using ASTM-D4274.

In some embodiments, the viscosity of the Aromatic Polyester Polyol Compound ranges from 200 to 50,000 centipoises (cps) (e.g., 1,000 to at 20,000 or 1,500 to 10,000) at 25° C. as measured using a Brookfield DV-II viscometer. In certain embodiments, the viscosity of the Aromatic Polyester Polyol Compound is lower than a corresponding polyol compound made to the same hydroxy number, aromatic content, and calculated functionality but without the use of Component (iii) (described below).

In certain embodiments, the Aromatic Polyester Polyol Compound has a bio-renewable content of at least 10% (e.g., ≥25% or ≥40%) by weight based on the total weight of the Aromatic Polyester Polyol Compound. Suitable bio-renewable materials that may be used in the synthesis of the Aromatic Polyester Polyol Compound include plant derived natural oils and the fatty acid components of such oils. Bio-renewable content can be measured using ASTM D6866. In some embodiments, the Aromatic Polyester Polyol Compound has a recycled content of at least 10% (e.g., ≥25% or ≥40%) by weight based on the total weight of the Aromatic Polyester Polyol Compound.

Other Polyol Compound

As stated above, the polyurethane foam composition disclosed herein can also comprise Other Polyol Compounds in addition to the Aromatic Polyester Polyol Compound described in the preceding sections. Polyol compounds or mixtures thereof that are liquid at 25° C., have a molecular weight ranging from 60 to 10,000 (e.g., 300 to 10,000 or less than 5,000), a nominal hydroxyl functionality of at least 2, and a hydroxyl equivalent weight of 30 to 2000 (e.g., 30 to 1,500 or 30 to 800) can be used as the Other Polyol Compound.

Examples of suitable polyols that may be used as the Other Polyol Compound include polyether polyols, such as those made by addition of alkylene oxides to initiators, containing from 2 to 8 active hydrogen atoms per molecule. In some embodiments, the initiators include glycols, glycerol, trimethylolpropane, triethanolamine, pentaerythritol, sorbitol, sucrose, ethylenediamine, ethanolamine, diethanolamine, aniline, toluenediamines (e.g., 2,4 and 2,6 toluenediamines), polymethylene polyphenylene polyamines, N-alkylphenylene-diamines, o-chloro-aniline, p-aminoaniline, diaminonaphthalene, or combinations thereof. Suitable alkylene oxides that may be used to form the polyether polyols include ethylene oxide, propylene oxide, and butylene oxide, or combinations thereof.

Other suitable polyol compounds that may be used as the Other Polyol Compound include Mannich polyols having a nominal hydroxyl functionality of at least 2, and having at least one secondary or tertiary amine nitrogen atom per molecule. In some embodiments, Mannich polyols are the condensates of an aromatic compound, an aldehyde, and an alkanol amine. For example, a Mannich condensate may be produced by the condensation of either or both of phenol and an alkylphenol with formaldehyde and one or more of monoethanolamine, diethanolamine, and diisopronolamine. In some embodiments, the Mannich condensates comprise the reaction products of phenol or nonylphenol with formaldehyde and diethanolamine. The Mannich condensates of the present disclosure may be made by any known process. In some embodiments, the Mannich condensates serve as initiators for alkoxylation. Any alkylene oxide (e.g., those alkylene oxides mentioned above) may be used for alkoxylating one or more Mannich condensates. When polymerization is completed, the Mannich polyol comprises primary hydroxyl groups and/or secondary hydroxyl groups bound to aliphatic carbon atoms.

In certain embodiments, the polyols that are used are polyether polyols that comprise propylene oxide (“PO”), ethylene oxide (“EO”), or a combination of PO and EO groups or moieties in the polymeric structure of the polyols. These PO and EO units may be arranged randomly or in block sections throughout the polymeric structure. In certain embodiments, the EO content of the polyol ranges from 0 to 100% by weight based on the total weight of the polyol (e.g., 50% to 100% by weight). In some embodiments, the PO content of the polyol ranges from 100 to 0% by weight based on the total weight of the polyol (e.g., 100% to 50% by weight). Accordingly, in some embodiments, the EO content of a polyol can range from 99% to 33% by weight of the polyol while the PO content ranges from 1% to 67% by weight of the polyol. Moreover, in some embodiments, the EO and/or PO units can either be located terminally on the polymeric structure of the polyol or within the interior sections of the polymeric backbone structure of the polyol. Suitable polyether polyols include poly(oxyethylene oxypropylene) diols and triols obtained by the sequential addition of propylene and ethylene oxides to di- or trifunctional initiators that are known in the art. In certain embodiments, Other Polyol Compound comprises the diols or triols described above or, alternatively, mixtures thereof.

Polyester polyols that can be used as the Other Polyol Compound include polyesters having a linear polymeric structure and a number average molecular weight (Mn) ranging from about 500 to about 10,000 (e.g., preferably from about 700 to about 5,000 or 700 to about 4,000) and an acid number generally less than 2.0 (e.g., less than 1.2). The molecular weight is determined by assay of the terminal functional groups and is related to the number average molecular weight. The polyester polymers can be produced using techniques known in the art such as: (1) an esterification reaction of one or more glycols with one or more dicarboxylic acids or anhydrides; or (2) a transesterification reaction (i.e. the reaction of one or more glycols with esters of dicarboxylic acids). Mole ratios generally greater than one mole of glycol to acid are preferred to obtain linear polymeric chains having terminal hydroxyl groups. Suitable polyester polyols also include various lactones that are typically made from caprolactone and a bifunctional initiator such as diethylene glycol. The dicarboxylic acids of the desired polyester can be aliphatic, cycloaliphatic, aromatic, or combinations thereof. Suitable dicarboxylic acids which can be used alone or in mixtures generally have a total of from 4 to 15 carbon atoms include succinic, glutaric, adipic, pimelic, suberic, azelaic, sebacic, dodecanedioic, phthalic, isophthalic, terephthalic, cyclohexane dicarboxylic, or combinations thereof. Anhydrides of the dicarboxylic acids (e.g., phthalic anhydride, tetrahydrophthalic anhydride, or combinations thereof) can also be used. In some embodiments, adipic acid is the preferred acid. The glycols used to form suitable polyester polyols can include aliphatic and aromatic glycols having a total of from 2 to 12 carbon atoms. Examples of such glycols include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, or combinations thereof.

Additional examples of suitable polyols include hydroxyl-terminated polythioethers, polyamides, polyesteramides, polycarbonates, polyacetals, polyolefins, polysiloxanes, and simple glycols such as ethylene glycol, butanediols, diethylene glycol, triethylene glycol, and propylene glycols such as dipropylene glycol, tripropylene glycol, and mixtures thereof.

Additional examples of suitable polyols include those derived from a natural source, such as plant oil, fish oil, lard, and tallow oil. Plant based polyols may be made from any plant oil or oil blends containing sites of unsaturation, including, but not limited to, soybean oil, castor oil, palm oil, canola oil, linseed oil, rapeseed oil, sunflower oil, safflower oil, olive oil, peanut oil, sesame seed oil, cotton seed oil, walnut oil, and tung oil.

The active hydrogen-containing material may contain other isocyanate reactive material such as polyamines and polythiols. Suitable polyamines include primary and secondary amine-terminated polyethers, aromatic diamines such as diethyltoluene diamine and the like, aromatic polyamines, or combinations thereof.

### Blowing Agent Compounds

As stated above, the polyurethane foam composition disclosed herein also comprises a blowing agent compound. Any physical blowing agent known in the art of PU and PIR foams can be used in the composition disclosed herein. For example, suitable blowing agent compounds include hydrocarbons, hydrochlorofluorocarbons, hydrofluorocarbons, hydrohaloolefins, or combinations thereof.

Examples of hydrocarbon blowing agents that may be used include lower aliphatic or cyclic, linear, or branched hydrocarbons (e.g., alkanes, alkenes and cycloalkanes, preferably those compounds having from 4 to 8 carbon atoms). Specific examples of suitable blowing agent compounds include n-butane, iso-butane, 2,3-dimethylbutane, cyclobutane, n-pentane, iso-pentane, technical grade pentane mixtures, cyclopentane, methylcyclopentane, neopentane, n-hexane, iso-hexane, n-heptane, iso-heptane, cyclohexane, methylcyclohexane, 1-pentene, 2-methylbutene, 3-methylbutene, 1-hexene, or combinations thereof.

Examples of suitable hydrochlorofluorocarbons include 1-chloro-1,2-difluoroethane, 1-chloro-2,2-difluoroethane, 1-chloro-1,1-difluoroethane, 1,1-dichloro-1-fluoroethane, monochlorodifluoromethane, or combinations thereof.

Examples of suitable hydrofluorocarbons include 1,1,1,2-tetrafluoroethane (HFC 134a), 1,1,2,2-tetrafluoroethane, trifluoromethane, heptafluoropropane, 1,1,1-trifluoroethane, 1,1,2-trifluoroethane, 1,1,1,2,2-pentafluoropropane, 1,1,1,3-tetrafluoropropane, 1,1,1,3,3-pentafluoropropane (HFC 245fa), 1,1,3,3,3-pentafluoropropane, 1,1,1,3,3-pentafluoro-n-butane (HFC 365mfc), 1,1,1,4,4,4-hexafluoro-n-butane, 1,1, 1,2,3, 3,3-heptafluoropropane (HFC 227ea), or combinations thereof.

Examples of suitable hydrohaloolefins are trans-1-chloro-3,3,3-fluoropropene (HFO 1233zd), trans-1,3,3,3-tetrafluoropropene (HFO 1234ze), cis- and trans-1,1,1,4,4,4-hexafluoro-2-butene (HFO 1336mzz), or combinations thereof.

Other suitable physical blowing agents are tertiary butanol (2-methyl-2-propanol), dimethoxymethane and methyl formate.

Chemical blowing agents, such as water, mono-carboxylic acid, and polycarboxylic acid (e.g., formic acid), can also be used as the sole blowing agent in the polyurethane foam composition disclosed herein. Alternatively, these chemical blowing agents can also be used in combination with the physical blowing agents described above as a co-blowing agent.

In some embodiments, the blowing agent compounds are used in an amount sufficient to give the final foam product the desired density of less than 20 lb/cu.ft (e.g., ≤10 lb/cu. Ft. or ≤4 lb/cu. ft.).

### Auxiliary Compounds and Additives

The polyurethane foam composition disclosed herein can also comprise one or more auxiliary compounds or additives that can be added to impart certain physical properties to the final foam product formed from the polyurethane foam composition. Examples of suitable auxiliary compounds and additives include catalysts, surfactants, fire retardants, smoke suppressants, cross-linking agents (e.g., triethanolamines and/or glycerol), viscosity reducers (e.g., propylene carbonate and/or dibasic esters), infra-red pacifiers (e.g., carbon black, titanium dioxide, and metal flakes), cell-size reducing compounds (e.g., insert, insoluble fluorinated compounds and perfluorinated compounds), pigments (e.g., azo-/diazo dyestuff and phthalocyanines), fillers (e.g., calcium carbonate), reinforcing agents (e.g., glass fibers and/or grounded foam waste), mold release agents (e.g., zinc stearate), anti-oxidants (e.g., butylated hydroxy toluene), dyes, anti-static agents, biocide agents, or combinations thereof.

Catalyst compounds that can accelerate/promote: (P) the reaction between the isocyanate compounds and the isocyanate reactive compounds; or (I) formation of isocyanurates (e.g., the reaction between isocyanate compounds) may be used in the polyurethane foam composition of the present disclosure. Suitable catalysts include urethane catalysts (e.g., tertiary amine catalysts), blowing catalysts, trimerization catalysts, or combinations thereof. Examples of such catalysts include dimethylcyclohexylamine, triethylamine, pentamethylenediethylenetriamine, tris (dimethylamino-propyl) hexahydrotriazine, dimethylbenzylamine, bis-(2-dimethylaminoethyl)-ether, dimethylethanolamine, 2-(2-dimethylamino-ethoxy)-ethanol; organometallic compounds such as potassium octoate, potassium acetate, dibutyltin dilaurate, dibutyltin diacetate, bismuth neodecanoate, 1,1′,1″,1′″-(1,2-ethanediyldinitrilo)tetrakis[2-propanol] neodecanoate complexes, 2,2′,2″,2′″-(1,2-ethanediyldinitrilo)tetrakis[ethanol] neodecanoate complexes, quaternary ammonium salts such as 2-hydroxpropyl trimethylammonium formate, or combinations thereof.

In some embodiments, the catalyst compounds can be used in an amount up to 5% (e.g., 0.5% to 3%) by weight of the polyurethane foam composition.

Foam formulators typically use surfactants in their foam compositions to control the cell structure of the final foam product. Accordingly, various surfactants (e.g., silicone and/or non-silicone-based surfactants) may be used in the polyurethane foam composition of the present disclosure. Examples of suitable surfactants include: (i) silicone surfactants including: (a) L-5345, L-5440, L-6100, L-6642, L-6900, L-6942, L-6884, L-6972; Evonik Industries DC-193, DC5357, Si3102, Si3103 (each available from Momentive Performance Materials Inc.); (b) Tegostab 8490, 8496, 8536, 84205, 84210, 84501, 84701, 84715 (each available from Evonik Industries AG), polyorganosiloxane polyether copolymers (e.g., polysiloxane polyoxyalkylene block co-polymers); (ii) non-silicone surfactants including non-ionic, anionic, cationic, ampholytic, semi-polar, and zwitterionic organic surfactants; (iii) non-ionic surfactants including: phenol alkoxylates (e.g., ethoxylated phenol compounds), alkylphenol alkoxylates (e.g, ethoxylated nonylphenol compounds), LK-443 (available from Evonik Industries AG), Vorasurf 504 (available from Dow Chemical Co), (iv) or combinations thereof.

In some embodiments, the surfactants can be used in an amount up to 5% (e.g., 0.5% to 3%) by weight of the polyurethane foam composition.

While one of the primary goals of the present disclosure is to provide a polyurethane foam composition that contains little to no fire retardants, these compounds can still be used in the polyurethane foam composition of the present disclosure. Examples of suitable flame retardants that may be used include: (i) organo-phosphorous compounds such as organic phosphates, phosphites, phosphonates, polyphosphates, polyphosphites, polyphosphonates, ammonium polyphosphates, triethyl phosphate, tris(2-chloropropyl)-phosphate, diethyl ethyl phosphonate, diethyl hydroxymethylphosphonate; dialkyl hydroxymethylphosphonate, Diethyl N,N bis(2-hydroxyethyl)aminomethylphosphonate; (ii) halogenated fire retardants (e.g., tetrabromophthalate diol and chlorinated parrafin compounds); or (iii) combinations thereof.

In some embodiments, the fire retardants can be used in an amount up to 15% (e.g., up to 10%) by weight of the polyurethane foam composition.

### Polyurethane/Polyisocyanurate Foam Product

A PU and/or PIR foam product is formed from the polyurethane foam composition of the present disclosure. In certain embodiments, a PU and/or PIR foam can be formed from the polyurethane foam composition disclosed herein by introducing the following components of the polyurethane foam composition with one another and allowing the reactive components to react: (1) an isocyanate compound; (2) one or more isocyanate reactive compounds (including the Aromatic Polyester Polyol Compound); (3) a blowing agent; and (4) additional additives. To form a PU foam product, the molar ratio of the isocyanate compound to the one or more isocyanate reactive compounds is near 1:1 (e.g., usually less than 2:1) while the molar ratio of the isocyanate compound to the one or more isocyanate reactive compound is greater than 1:1 (e.g., 2:1) when forming a PIR foam product.

The materials described above can be used as Components 1, 2, 3, or 4. The components can be introduced to one another in multiple streams (i.e., at least two streams). In some embodiments, one stream comprises the isocyanate compound while the other stream comprises the one or more isocyanate reactive compounds. In certain embodiments, the stream comprising the isocyanate reactive compounds can also comprise other materials (e.g., auxiliary additives/compounds) so long as they are not reactive toward the isocyanate reactive compounds. It is noted that the stream comprising the isocyanate compound can also comprise other materials (e.g., auxiliary additives/compounds) provided that the materials are not reactive toward the isocyanate compound. In some embodiments, the blowing agent is introduced in a third stream that is separate and distinct from the streams that comprise the isocyanate compound and the isocyanate reactive compounds. While the auxiliary additives/compounds may be introduced in one or more of the streams, the auxiliary additives may also be introduced in one or more additional streams (e.g., a catalyst stream) that is separate and distinct from the streams described above if desired.

Mixing of the streams may be carried out either in a spray apparatus (e.g., spray gun), a mix head (including those with or without a static mixer), or some other type of vessel that is configured to spray or otherwise deposit the components of the polyurethane foam composition disclosed herein onto a substrate.

In some embodiments, the isocyanate compound and the one or more isocyanate reactive compounds of the polyurethane foam composition are reacted at an NCO index of up to 1000%. In some embodiments, the NCO index ranges from 20% to 180% (e.g., 40% to 160%). For urethane-modified polyisocyanurate foams, the NCO index is typically higher (e.g., from 180% to 1000% or 200% to 500% or 250% to 500%).

In some embodiment, the PU and/or PIR products exhibit higher compressive strength as measured by ASTM D1621, Procedure A. Compressive strength is nominally measured on 5 cm×5 cm×2.5 cm foam with 2.5 cm dimension being in rise and cross-rise directions.

In some embodiment, the PU and/or PIR products exhibit improved dimensional stability as measured by ASTM D2126, each of 7 days at −40° C./ambient % RH and 7 days at 70° C./97% RH using 10 cm×10 cm×2.5 cm foam.

Use of Polyurethane Foam Composition

The polyurethane foam composition disclosed herein can be used in applications requiring high heat/thermal resistance (e.g., ≥121.1° C.), heat distortion, flammability resistance, and/or char integrity. The PU and/or PIR foam product made from the polyurethane foam composition disclosed herein may be produced in a form that is well known to those skilled in art of polyurethanes. For example, suitable forms include slabstock, moldings, cavity filling (e.g., pour-in-place foam), spray-in-place foam, frothed foam, or laminate (e.g., foam product combined with another material such as paper, metal, plastics or wood-board).

Construction and Other Industrial Applications

In the United States of America, model building codes require that materials used in commercial/residential buildings and homes meet certain fire performance criteria depending on whether the material will be used in roofs, walls, ceilings, attics, or crawl spaces. The criteria are measured by fire test including ASTM E84, E108, E119, E662, E2074; FM 4450, 4880; NFPA 285, 286; and UL 1040, 1256. The PUR and PIR foam produced from the polyurethane foam composition disclosed herein can be used to meet one or more of the fire tests described above while significantly reducing or eliminating the use of fire retardants.

While the polyurethane foam composition disclosed herein can be applied onto various types of substrates, in some embodiments, the substrate is a rigid or flexible facing sheet made of foil or another material (including another layer of similar or dissimilar polyurethane) which is being conveyed (continuously or discontinuously) along a production line by means such as a conveyor belt. In certain embodiments, the facing sheet is used to manufacture building panels that are used in the construction industry.

In another embodiment, the polyurethane foam composition disclosed herein is used in the continuous production of PU or PIR based metal panels. In this application, the polyurethane foam composition is applied via one or more mix heads to a lower metal layer (which can be profiled) in a double band laminator. In some embodiments, the line speed of the laminator is set at a speed of 75 ft/min or less. In the laminator, a continuously formed metal panel is made when the rising foam composition reaches the upper surfacing layer. The formed metal panel is then cut to a desired length at the exit end of the laminator. Suitable metals that may be used in this application include aluminum or steel which can be coated with a polyester or epoxy layer to help reduce the formation of rust while also promoting adhesion of the foam to the metal layer. In some embodiments, the final foam metal panel comprises a foam thickness ranging from 1 inch to 8 inches.

In another embodiment, the polyurethane foam composition disclosed herein is used in the continuous production of PU and/or PIR foam laminate insulation board and cover board, generically referred to as boardstock. In this process, the foaming mixture is applied via one or more mix heads to the lower facer layer in a double band laminator. In some embodiments, the line speed of the laminator is set at a speed of 300 ft/min or less. In the laminator, a continuously formed board is made when the rising foam mixture reaches the upper facer layer. Like the metal panels described above, the boards are then cut to a desired length at the exit end of the laminator. Suitable materials that may be used in the facer include aluminum foil, cellulosic fibers, reinforced cellulosic fibers, craft paper, coated glass fiber mats, uncoated glass fiber mats, chopped glass, or combinations thereof. In some embodiments, the final foam laminate board has a foam thickness ranging from 0.25 inches to 5 inches.

It is noted that in the examples described above, the upper facer layer may be applied on top of the deposited composition either before or after the polyurethane foam composition is partially or fully cured.

In alternative embodiment, the polyurethane foam composition disclosed herein can be poured into an open mold (including being distributed via laydown equipment into an open mold) or simply deposited at or into a desired location (i.e., a pour-in-place application) such as between the interior and exterior walls of a structure. In general, such applications may be accomplished using the known one-shot, prepolymer or semi-prepolymer techniques used in combination with conventional mixing methods. Upon reacting, the polyurethane foam composition will take the shape of the mold or adhere to the substrate onto which it is deposited. The polyurethane foam composition is then allowed to either fully or partially cure in place.

In certain embodiments, the polyurethane composition can be injected into a closed mold thereby forming a molded polyurethane foam product. In these applications, the polyurethane composition can be injected with or without vacuum assistance.

If a mold is employed (irrespective of whether it is an open or closed mold), then the mold can be heated to facilitate the handling and workability of the polyurethane composition (e.g., facilitate flow of the polyurethane foam composition in the mold).

Pipe Line Applications

To achieve desired heat/thermal and flammability resistance requirements, the polyurethane foam composition disclosed herein can be used in pipeline applications (e.g., pipelines used in the transport of oil, bitumen, natural gas, petroleum, hot water, or steam (both pressurized and non-pressurized).

In piping applications, the polyurethane foam composition disclosed herein can be introduce discontinuously into the hollow space between a pipe (e.g., metal pipe made from steel) and an outer sheathing (e.g., a plastic sheathing made from polyethylene) thereby forming an insulated pipe. Alternatively, the polyurethane foam composition can be applied continuously to a pipe around which the sheathing layer is subsequently laid either before or after the polyurethane foam composition has fully cured thereby forming an insulated pipe.

Spray Foam

The polyurethane foam composition disclosed herein can be applied onto a substrate using a proportioning system or some other mean of spraying. The proportioning system, which may be a fixed ratio system, comprises a resin composition supply vessel, an isocyanate component supply vessel, a spray machine, and a spray gun comprising a mixing chamber. The composition comprising the isocyanate reactive compounds (e.g., the Aromatic Polyester Polyol Compound), blowing agent, and other auxiliary additives (collectively, “Resin Composition”) is pumped in a first stream from the resin composition supply vessel to the spray machine. The isocyanate compound is pumped in a second stream, which is separate and distinct from the Resin Composition, from the isocyanate component supply vessel to the spray machine. The isocyanate component and Resin Composition are heated and pressurized in the spray machine and supplied to the spray gun in two separate heated hoses to form the polyurethane foam composition. The polyurethane composition is then provided to the spray gun, which is used to: (i) mix the isocyanate compound and the Resin Composition and (ii) spray the polyurethane composition onto the substrate.

Suitable substrates that can be sprayed with the polyurethane foam composition include sheathing materials (e.g., oriented strand board (OSB), plywood, gypsum sheetrock, foam board, fiberboard and cellulosic sheathing); wood, concrete, polyvinyl chloride, metal, or combinations thereof. In certain embodiments, the PU and/or PIR foam product may be formed in-situ over regular or irregular surfaces (e.g., on commercial and residential wall, ceiling, floor or other substrates) of a structure.

In some embodiments, a spray-in-place foam made the polyurethane foam composition disclosed herein may achieve Class I rating in ASTM E84 without using the use of a fire retardant such as tris(1-chloro-2-propyl)phosphate (TCPP).

### Method of Making an Aromatic Polyester Polyol Compound

The present disclosure is also directed to a method of making the Aromatic Polyester Polyol Compound. The method comprises reacting at esterification reaction conditions a reactive mixture comprising the following components:
(i) an aromatic acid compound;
(ii) an aliphatic diol compound;
(iii) a dialkylol alkanoic acid compound of Formula I:

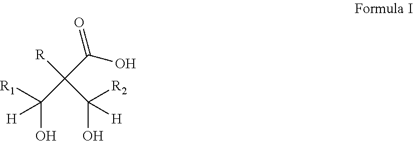

wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, methyl, or ethyl; and
(iv) optionally, a polyhydroxy compound comprising at least three hydroxyl groups, a hydrophobic compound, or combinations thereof; and
wherein the aromatic polyester polyol compound is liquid at 25° C. and has a hydroxy value ranging from 30 to 600.

The Aromatic Polyester Polyol Compound of the present disclosure is made by placing Components (i) to (iv), which are described in greater detail below, into a reaction vessel and subjecting the reactive mixture to esterification/transesterification reaction conditions at temperatures ranging from 50° C. to 300° C. for a time period ranging from 1 hour to 24 hours (e.g., 3 hours to 10 hours). In some embodiments, two or more of Components (i) to (iv) may be pre-reacted with one another to form an intermediate product. The intermediate product can then be introduced into a reaction vessel with the remaining components and subjected to esterification/transesterification reaction conditions to form the Aromatic Polyester Polyol Compound. Any volatile by-products of the reaction, such as water or methanol, can be removed from the process thereby forcing the ester interchange reaction to completion. While the synthesis of the Aromatic Polyester Polyol Compound may take place under reduced or increased pressure, the reaction is generally carried out near atmospheric pressure conditions.

An esterification/transesterification catalyst may be used during synthesis to increase the rate of reaction. Examples of suitable esterification/transesterification catalyst include tin catalysts (e.g., FAST Cat catalyst available from Arkema, Inc.), titanium catalyst (e.g., TYZOR TBT catalyst, TYZOR TE catalyst both available from Dork Ketal Chemical LLC), alkali catalysts (e.g., sodium hydroxide, potassium hydroxide, sodium and potassium alkoxides), acid catalyst (e.g., sulfuric acid, phosphoric acid, hydrochloric acid, sulfonic acid), enzymes, or combinations thereof. The esterification/transesterification catalyst can be present in an amount ranging from 0.001% to 0.2% by weight of based on the total weight of the aromatic polyester polyol composition.

### Component (i): Aromatic Acid Compound

Suitable aromatic acid compounds that may be used as Component (i) include terephthalic acid, phthalic anhydride, phthalic acid, isophthalic acid, 2,6-naphthalene dicarboxylic acid, trimellitic anhydride, hemimellitic anhydride, pyromellitic dianhydride, mellophanic dianhydride, methyl esters of phthalic, isophthalic, terephthalic acid, and 2,6-naphthalene dicarboxylic acid, or combinations thereof.

Other compounds that may be used as Component (i) also include more complex ingredients such as the side stream, waste, and/or scrap residues from the manufacture of the compounds listed above, the byproduct of aromatic carboxylic acid (BACA), or combinations thereof.

Yet other compounds that may be used as Component (i) include polyalkylene terephthalate polymers (e.g., polyethylene terephthalate (PET), polybutylene terephthalate (PBT), polytrimethylene terephthalate (PTT), glycol-modified polyethylene terephthalate (PETG)), copolymers of terephthalic acid and 1,4-cyclohexanedimethanol (PCT), polyethylene napthalate (PEN), or combinations thereof.

Any of these polymers may be obtained from recycled or used objects that have been discarded including photographic films, X-ray films, synthetic fibers, plastic bottles or other related containers widely used in the soft drink industry, recycled materials generated during the production of other products, such as those made from polyalkylene terephthalate polymers, or combinations thereof. For example, rPET and/or rPTT can be derived from the post-consumer waste stream of plastic bottles or other related containers as well as from post-industrial or post-consumer carpet. In these embodiments, the rPET may contain minor proportion of organic and/or inorganic foreign matters (e.g., paper, dyes, other plastics, glass, or metal). In certain embodiments, rPET and/or rPTT can either be in flake or pelletized form. Oligomeric materials derived from PET and/or PTT may also be used. These materials can be manufactured by reacting PET and/or PTT with one or more glycols, optionally in the presence of a catalyst, under reactive condition that can partially depolymerize the PET and/or PTT.

Component (i) may be present in an amount ranging from 5% to 70% (e.g., 10% to 50% or 15% to 45%) by weight based on the total weight of the aromatic polyester polyol composition.

### Component (ii): Aliphatic Diol Compound

Suitable aliphatic diol compounds that may be used as Component (ii) include compounds having the following structure:

OH—R—OH
wherein R is a divalent radical selected from the group consisting of: (i) alkylene radicals containing 2 to 12 carbon atoms (with or without alkyl branches); or (ii) radicals of the following structure:

—[(R′O)ₙ—R′]—
wherein R′ is an alkylene radical containing 2 to 4 carbon atoms and n is an integer from 1 to 10.

Examples of suitable aliphatic diol compounds that may be used as Component (ii) include ethylene glycol; diethylene glycol; triethylene glycol; tetraethylene glycol; propylene glycol; dipropylene glycol; tripropylene glycol; butylene glycol; 1,4-butanediol; neopentyl glycol; poly(oxyalkylene) polyols containing 2 to 4 alkylene radicals derived by the condensation of ethylene oxide, propylene oxide, or combinations thereof; 2-methyl-2,4-pentanediol; 1,6-hexanediol; 1,2-cyclohexanediol; or combinations thereof.

Component (ii) may be present in an amount ranging from 5% to 60% (e.g., 10% to 50% or 15% to 45%) by weight based on the total weight of the aromatic polyester polyol composition.

### Component (iii): Dialkylol Alkanoic Acid

The dialkylol alkanoic acid compound used as Component (III) has the structure shown in Formula I:

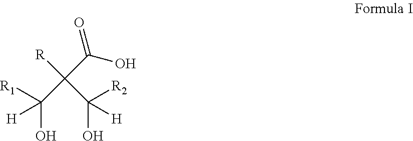

wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic. Examples include hydrogen, methyl, ethyl, isopropyl, hydroxymethyl, hydroxyethyl, phenyl, tolyl, naphthyl, cyclopentyl, cyclohexyl. Preference is given to methyl, ethyl, propyl, butyl, phenyl, and tolyl;
wherein R1, R2 are each independently hydrogen, C₁ to C₈ alkyl (straight-chain or branched). Examples include hydrogen, methyl, ethyl, iso-propyl, n-propyl, n-butyl, isobutyl, sec-butyl, tert-butyl, n-pentyl, n-hexyl, n-heptyl, n-octyl.

Examples of dialkylol alkanoic acid compounds that may be used as Component (iii) include 2,2-bis(hydroxymethyl)propionic acid (DMPA); 2,2-bis(hydroxymethyl)butanoic acid (DMBA); 2,2-bis(hydroxymethyl)pentanoic acid (DMPTA); 2-2-bis(hydroxymethyl)hexanoic acid (DMHA); 2,2,2-trimethylol acetic acid (TMAA); and 2,2-bis(hydroxymethyl)benzoic acid; 2,2-bis(hydroxymethyl)toluic acid, or combinations thereof.

Component (iii) may be present in an amount ranging from 0.1% to 30% (e.g., 0.5% to 25% or 1% to 15%) by weight based on the total weight of the aromatic polyester polyol composition.

### Component (iv): Optional Additives

Component (iv) can contain a polyhydroxy compound comprising at least three hydroxyl groups, a hydrophobic compound, or combinations thereof.

Suitable polyhydroxy compounds that may be used as Component (iv) include low molecular weight compounds containing 3 to 8 hydroxy groups. Examples of suitable polyhydroxy compounds include glycerin; alkoxylated glycerin; 1,1,1-trimethylolpropane, 1,1,1-trimethylolethane; pentaerythritol; dipentaerythritol; sucrose; alkoxylated sucrose; methyl glucoside; alkoxylated methyl glucoside; glucose; alkoxylated glucose; fructose; alkoxylated fructose; sorbitol; alkoxylated sorbitol; lactose; alkoxylated lactose; mannitol; digylcerol; erythritol; xylitol; or combinations thereof.

In certain embodiments, the hydrophobic compounds that may be used as Component (iv) include those compounds that are not derived from aromatic acids. Examples of suitable hydrophobic compounds include carboxylic acids (e.g., fatty acid compounds such as caproic, caprylic, 2-ethylhexanoic, capric, lauric, myristic, palmitic, stearic, oleic, linoleic, linolenic, and ricinoleic compounds); lower alkanol esters of carboxylic acids (e.g., fatty acid methyl ester compounds such as methyl caproate, methyl caprylate, methyl caprate, methyl laurate, methyl myristate, methyl palmitate, methyl oleate, methyl stearate, methyl linoleate, and methyl linolenate); fatty acid alkanolamides (e.g., tall oil fatty acid diethanolamide, lauric acid diethanolamide, and oleic acid monoethanolamide); triglycerides (e.g., fats and oils such as castor oil, coconut (including cochin) oil, corn oil, cottonseed oil, linseed oil, olive oil, palm oil, palm kernel oil, peanut oil, soybean oil, sunflower oil, tall oil, tallow, and derivatives of natural oil or functionalized, such as epoxidized, natural oil); alkyl alcohols (e.g., alcohols containing 4 to 18 carbon atoms per molecule such as decyl alcohol, oleyl alcohol, cetyl alcohol, isodecyl alcohol, tridecyl alcohol, lauryl alcohol, and mixed C₁₂-C₁₄ alcohol); or combinations thereof.

Component (iv) may be present in an amount ranging from 0% to 30% (e.g., 0% to 20% or 0% to 15%) by weight based on the total weight of the aromatic polyester polyol composition.

### Other Additives

The reactive mixture used to make the Aromatic Polyester Polyol Compound can also contain minor amounts of dyes, antioxidants, ultraviolet stabilizers, acid scavengers, or combinations thereof. These additives may be present in an amount of ≤1% (e.g., ≤0.5%) by weight based on the total weight of the aromatic polyester polyol composition.

In certain embodiments, a non-ionic surfactant compound may also be used as an additive. These non-ionic surfactants may contain one or more hydrophobic moieties and one or more hydrophilic moieties. However, the non-ionic surfactants do not contain any moieties that dissociate into cations or anions when subjected to an aqueous solution or dispersion. While nearly any non-ionic surfactant compound may be used, a suitable surfactant is a polyoxyalkylene surfactant compound containing an average of 4 to 200 individual oxyalkylene groups per molecule wherein the oxyalkylene group is selected from the group consisting of oxyethylene, oxypropylene, or combinations thereof. The non-ionic surfactant compound can be present in an amount ranging from 0% to 20% by weight based on the total weight of the aromatic polyester composition.

### Modifications

While specific embodiments of the present disclosure have been described in detail, it will be appreciated by those skilled in the art that various modifications and alternatives to those details could be developed considering the overall teachings of the disclosure. Accordingly, the arrangements disclosed are meant to be illustrative only and not limiting as to the scope of the disclosure which is to be given the full breadth of the claims appended and all equivalents thereof. Therefore, any of the features, properties, and/or elements which are listed above may be combined with one another in any combination and still be within the breadth of this disclosure.

### Examples

Raw Material and Components:

The following reaction components, raw material and terms are referred to in the Examples:

DEG: Diethylene glycol available from Equistar Chemicals, LP.

DMBA: Dimethylolbutyric acid available from MilliporeSigma.

DMPA: Dimethylolpropionic acid available from MilliporeSigma.

Glycerin: Available from Terra Biochem LLC.

PE: Pentaerythriol available from Perstorp Polyols, Inc.

PTA: Purified terephthalic acid available from Grupo Petrotemex.

SBO: Refined soybean oil available from Archer Daniels Midland Company.

TEG: Triethylene glycol available from The Dow Chemical Company.

TTEG: Tetraethylene glycol available from The Dow Chemical Company.

TYZOR TE: Titanium (triethanolaminato) isopropoxide solution 80 wt % in isopropanol available from Dorf Ketal Specialty Catalyst LLC.

JEFFOL® SD-361: A reactive sucrose/diethylene glycol initiated propylene oxide polyol having an OH value of 360 mg KOH/g (available from Huntsman International LLC).

TCPP: Tris(2-chloroisopropyl) phosphate (available from Lanxess Corporation as LEVAGARD® PP).

PHT4-Diol LV: a tetrabromophthalate diol that is used as a flame retardant in rigid polyurethane foams (available from Lanxess).

DABCO® DC193: A silicone surfactant (available from Evonik Industries AG).

JEFFCAT® DM-70: A polyurethane amine catalyst (available from Huntsman International LLC).

DABCO® T-120: An organotin catalyst (available from Evonik Industries AG).

POLYCAT® 218: A polyurethane amine catalyst (available from Evonik Industries AG).

SOLSTICE® LBA: 1-Chloro-3,3,3-trifluoropropene (available from Honeywell International Inc.).

RUBINATE® M: Polymeric MDI having an NCO value of 30.5% (available from Huntsman International LLC).

### Analysis and Testing

The following terms are referred to in the Examples:

Acid number: a measurement of residue acid determined by standard titration techniques (e.g., ASTM D4662).

Aromatic content: Weight percent of benzene di-radicals in the final polyol product calculated from benzene ring containing raw material used in the polyol synthesis.

FN: Functionality of polyol is the average number of OH groups in each molecule defined as the ratio of a mole of OH groups and a mole of molecules in a certain quantity of polyol product calculated from the polyol raw material composition.

Hydrophobic content: Weight percentage of aliphatic chain radical in the final polyol product calculated from the hydrophobic compound raw material used in the polyol synthesis.

OH number: Hydroxyl number which is a measurement of the number of OH groups determined by standard titration techniques (e.g., ASTM D4274).

Viscosity: Dynamic viscosity measured using a Brookfield Viscometer (e.g., Brookfield DV-II viscometer).

Cream time: the elapsed time between the moment a composition's isocyanate component is mixed with the composition's isocyanate reactive component and the formation of the fine froth or cream in the composition.

Tack free time: the elapsed time between the moment a composition's isocyanate component is mixed with the composition's isocyanate reactive component and the point at which the outer skin of the foam loses its stickiness or adhesive quality. Experimentally, such loss of stickiness is when a 6″ wooden tongue depressor (e.g., Puritan 705) is brought into contact with the surface of the reaction mixture and appears non-sticky when it is removed from the surface.

FRD (Free rise density): the density of a foam sample taken from the center of a cup foam.

### Polyol-1 (Comparative)

264 g of PTA, 10.9 g of PE, 82 g of Glycerin, 110 g of TTEG, 139 g of TEG, 89 g of DEG, and 62 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1 was then cooled to room temperature, and the acid number, OH number and viscosity were measured.

### Polyol-1A (Inventive)

264 g of PTA, 8.1 g of DMPA, 89 g of Glycerin, 110 g of TTEG, 136 g of TEG, 89 g of DEG, and 62 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1A was then cooled to room temperature, and the acid number, OH number and viscosity were measured.

### Polyol-1B (Inventive)

264 g of PTA, 24.3 g of DMPA, 78 g of Glycerin, 90 g of TTEG, 111 g of TEG, 132 g of DEG, and 62 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1B was then cooled to room temperature, and the acid number, OH number and viscosity were measured.

### Polyol-1C (Inventive)

264 g of PTA, 23.9 g of DMBA, 80 g of Glycerin, 90 g of TTEG, 111 g of TEG, 130 g of DEG, and 62 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-1C was then cooled to room temperature, and the acid number, OH number, and viscosity were measured.

### Polyol-2 (Comparative)

259 g of PTA, 21.2 g of PE, 77 g of Glycerin, 108 g of TTEG, 167 g of TEG, 64 g of DEG, and 61 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2 was then cooled to room temperature, and the acid number, OH number, and viscosity were measured.

### Polyol-2A (Inventive)

266 g of PTA, 8.1 g of DMPA, 102 g of Glycerin, 118 g of TTEG, 136 g of TEG, 67 g of DEG, and 61 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2A was then cooled to room temperature, and the acid number, OH number, and viscosity were measured.

### Polyol-2B (Inventive)

265 g of PTA, 24.3 g of DMPA, 91 g of Glycerin, 93 g of TTEG, 133 g of TEG, 93 g of DEG, and 61 g of SBO were added to a 500 mL cylindrical glass reactor. Under a ˜0.3 to 0.5 liter per minute (LPM) flow of nitrogen, the reaction mixture was heated to 240° C. The temperature was then maintained at 240° C. and the condensation water was collected. When the head temperature dropped below 70° C. (˜4 hours later), 0.7 g of Tyzor TE was added. The reaction was then heated at 240° C. until the acid value was below 2.0 mg KOH/g (˜2 hours later). The reaction was then cooled to room temperature and the initial OH number was measured. DEG was then added to the reactor based on calculation to adjust the OH number to the calculated 350 mg KOH/g while blending the mixture at 80° C. for 30 minutes. The final Polyol-2B was then cooled to room temperature, and the acid number, OH number, and viscosity were measured.

### Summary of Polyol Properties

TABLE 1

| | Polyols | | | |
|---|---|---|---|---|
| | | Polyol- | Polyol- | Polyol- |
| | Polyol-1 | 1A | 1B | 1C |
| DMPA (per 100 parts | 0.0 | 1.15 | 3.47 | |
| final polyol) | | | | |
| DMBA (per 100 parts | 0.0 | | | 3.42 |
| final polyol) | | | | |
| Acid number (mg KOH/g) | 0.8 | 1.0 | 1.4 | 0.8 |
| OH number (mg KOH/g) | 350.8 | 349.6 | 352.0 | 347.5 |
| Functionality (number based) | 2.50 | 2.50 | 2.50 | 2.50 |
| Hydrophobic content (%) | 7.14 | 7.10 | 7.06 | 7.09 |
| Aromatic content (%) | 17.29 | 17.25 | 17.22 | 17.27 |
| Viscosity (25° C., cPs) | 4,699 | 4,359 | 3,669 | 4,181 |

TABLE 2

| | Polyols | | |
|---|---|---|---|
| | Polyol-2 | Polyol-2A | Polyol-2B |
| DMPA (per 100 parts final polyol) | 0.00 | 1.15 | 3.43 |
| Acid number (mg KOH/g) | 1.1 | 0.8 | 1.1 |
| OH number (mg KOH/g) | 354.0 | 353.3 | 357.3 |
| Functionality (number based) | 2.56 | 2.60 | 2.58 |
| Hydrophobic content (%) | 6.97 | 7.02 | 6.96 |
| Aromatic content | 16.97 | 17.41 | 17.18 |
| Viscosity (25° C., cPs) | 5,939 | 5,419 | 4,799 |

As shown in Table 1 and Table 2, the inventive polyols have lower viscosities than the comparative polyols while maintaining similar properties (e.g., acid number, OH number, functionality, hydrophobic content, and aromatic content) to the comparative polyols. The lower viscosity of the inventive polyols improves the ability to mix these compounds with other components used to make polyurethane and polyisocyanurate based foam. Better mixing typically leads to improved properties in the foam products.

Description of Making Polyurethane Cup Foams

The composition of the formulation is listed in Table 3. The foams used for FRD, compressive strength and dimensional stability tests were made by the following steps: (i) cool both polyol premix and isocyanate in a 15° C. fridge for 2 hours; (ii) pouring the contents of the polyol premix and isocyanate into a 32-oz non-waxed paper cup (e.g., Solo H4325-2050) according to the corresponding Isocyanate/Premix ratios listed in Table 4 and Table 5 thereby combining the two components so the total weight is 120 gram and the isocyanate index is 110%; (iii) mixing the combined components for 4 seconds at 2500 rpm using a mechanical mixer (e.g., Caframo BDC3030 stirrer); (iv) allowing the components of the composition to react thereby forming the polyurethane foam product, and recording the reactivities (Cream time and Tack free time); (v) store the foam at room temperature and humidity for 24 hours; and (vi) cut a 5 cm×5 cm×5 cm sample from about 6 cm under the foam top surface to measure FRD. Reactivities and FRDs are summarized in Table 4 and Table 5.

TABLE 3

| | Parts by Weight |
|---|---|
| Polyol Premix | |
| Aromatic Polyester Polyol | 61.47 |
| JEFFOL ® SD-361 | 11.0 |
| DABCO ® DC193 | 1.0 |
| JEFFCAT ® DM-70 | 1.0 |
| DABCO ® T-120 | 0.5 |
| POLYCAT ® 218 | 2.28 |
| TCPP | 6.0 |
| PHT-4 Diol LV | 3.0 |
| SOLSTICE ® LBA | 12.0 |
| Water | 1.75 |
| Total Polyol Premix | 100.0 |
| Isocyanate | |
| RUBINATE ® M | Varies |
| Isocyanate/Premix ratio | Varies |
| Isocyanate Index | 110% |

TABLE 4

| | Polyols | | | |
|---|---|---|---|---|
| | Polyol-1 | Polyol-1A | Polyol-1B | Polyol-1C |
| Isocyanate/ | 51.72/48.28 | 51.69/48.31 | 51.76/48.24 | 51.61/48.39 |
| Premix ratio | | | | |
| Cream time (s) | 4-5 | 4-5 | 4-5 | 4-5 |
| Tack free | 9-10 | 9-10 | 9-10 | 9-10 |
| time (s) | | | | |
| FRD (lb/ft³) | 1.84 | 1.85 | 1.83 | 1.83 |

TABLE 5

| | Polyols | | |
|---|---|---|---|
| | Polyol-2 | Polyol-2A | Polyol-2B |
| Isocyanate/Premix ratio | 51.84/48.16 | 51.81/48.19 | 51.95/48.05 |
| Cream time (s) | 4-5 | 4-5 | 4-5 |
| Tack free time (s) | 9-10 | 9-10 | 9-10 |
| FRD (1b/ft3) | 1.85 | 1.82 | 1.86 |

As shown in Table 4 and Table 5, the inventive polyols exhibited the identical reactivities to the corresponding comparative polyols while also having nearly the same density. This allows the comparison of the physical properties to be meaningful.

Description of the Foam Compressive Strength and Dimensional Stability Tests:

Measurement of the Compressive Strength: Two 5 cm×5 cm×2.5 cm samples were taken from each cup foam core. The rise direction sample was taken so the 2.5 cm thickness side is along the foam rise direction while the top surface is at the cup edge height. The cross-rise direction sample was taken right above the rise direction sample so the 2.5 cm thickness side is perpendicular to the foam rise direction. The compressive strength measurement was done following the ASTM D-1621, Procedure A.

Measurement of the foam Dimensional Stability: A 10 cm×10 cm×2.5 cm sample was cut from about 3 cm under the top surface of a cup foam. The dimensional changes after 7 days of aging were measured following the ASTM D-2126. Two aging conditions were evaluated including 70° C. at 97% humidity and −40° C., at ambient humidity.

TABLE 6

| | Polyols | | | |
|---|---|---|---|---|
| | | Polyol- | Polyol- | Polyol- |
| | Polyol-1 | 1A | 1B | 1C |
| Compressive strength (psi, rise) | 27.6 | 32.1 | 29.5 | 30.2 |
| Compressive strength (psi, cross-rise) | 16.1 | 18.5 | 17.5 | 17.6 |
| Normalized MCS @ 2.0 lb/ft³ | 31.6 | 36.4 | 34.1 | 34.8 |

Dimensional stability (70° C., 97% humidity, 7 days aging)

| | | | | |
|---|---|---|---|---|
| Length change (%) | −0.43 | −0.05 | −0.01 | 0.03 |
| Width change (%) | −0.38 | 0.06 | 0.14 | 0.04 |
| Thickness change (%) | 0.17 | 0.72 | 0.51 | 0.93 |
| Volume change (%) | −0.63 | 0.74 | 0.64 | 1.00 |

Dimensional stability (−40° C., ambient humidity, 7 days aging)

| | | | | |
|---|---|---|---|---|
| Length change (%) | 0.05 | 0.09 | 0.03 | 0.03 |
| Width change (%) | −0.03 | 0.04 | 0.08 | 0.06 |
| Thickness change (%) | −0.03 | 0.09 | 0.09 | 0.12 |
| Volume change (%) | −0.01 | 0.23 | 0.20 | 0.20 |

TABLE 7

| | Polyols | | |
|---|---|---|---|
| | Polyol-2 | Polyol-2A | Polyol-2B |
| Compressive strength (psi, rise) | 29.1 | 30.3 | 29.1 |
| Compressive strength (psi, cross rise) | 17.9 | 17.7 | 17.5 |
| Normalized MCS @ 2.0 lb/ft³ | 33.0 | 35.3 | 32.7 |

Dimensional stability (70° C., 97% humidity, 7 days aging)

| | | | |
|---|---|---|---|
| Length change (%) | −0.28 | −0.05 | −0.05 |
| Width change (%) | −0.19 | −0.32 | −0.04 |
| Thickness change (%) | −0.05 | −0.02 | −0.06 |
| Volume change (%) | −0.52 | −0.40 | −0.14 |

Dimensional stability (−40° C., ambient humidity, 7 days aging)

| | | | |
|---|---|---|---|
| Length change (%) | 0.06 | 0.06 | 0.07 |
| Width change (%) | 0.18 | 0.03 | 0.05 |
| Thickness change (%) | 0.04 | 0.18 | 0.12 |
| Volume change (%) | 0.28 | 0.27 | 0.23 |

As shown in Table 6 and Table 7, the foams made from the inventive polyols exhibited similar dimensional stability data as the corresponding foams made from the comparative polyols. All the dimensional changes are well within the typical requirement (within −1% and +1% on length and width, within −4% and +4% on thickness). Another aspect of foam physical property is the compressive strength. A better comparison can be done by using a principle called geometric mean of compressive strength (MCS) measured in each of the three principal axes of the cup foam core sample (rise, and cross-riseX2) which is an indicator of polymer strength of the foam without the vagaries of cell orientation. The following relationship between MCS and core foam density has been observed historically for closed cell polyurethane foam and was found to hold for foams made in this study.

MCS=Material Constant X Density^{1.61} (as described in Singh S., Eubank J., Coleman P., Shieh, D., Donald R., and Pilgrim J. 2016 “Advances in Aromatic Polyester Polyols for Polyisocyanurate Thermal Insulation Board,” Proceedings of 2016 Polyurethanes Technical Conference, which is incorporated herein by reference).

The value of the “Material Constant” remains the same as long as density is changed in a relatively narrow range by varying the amount of blowing agent while keeping the formulation and processing essentially the same. Besides the actual compressive strength at both rise and cross-rise directions, the Tables also showed the calculated Normalized MCS at 2.0 lb/ft³=(CS-rise×CS-cross-rise×CS-cross-rise)^{1/3}×(2.0/core foam density)^{1.61}. The foams made from the inventive polyols showed similar or stronger polymer strength than the foams made from the corresponding comparative polyols.

What is claimed is:

1. A polyurethane foam composition comprising:
(a) an isocyanate compound;
(b) one or more isocyanate reactive compounds wherein at least one of the isocyanate reactive compounds comprises an aromatic polyester polyol compound that is the esterification reaction product of the following components:
(i) an aromatic acid compound;
(ii) an aliphatic diol compound;
(iii) a dialkylol alkanoic acid compound of Formula I: 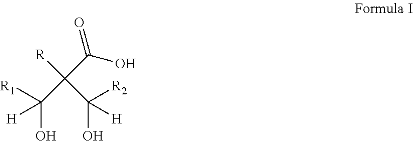
wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, C₁ to C₈ alkyl (straight-chain or branched); and
(iv) optionally, a hydrophobic compound, a polyhydroxy compound comprising at least three hydroxyl groups, or combinations thereof; and
wherein the aromatic polyester polyol compound is liquid at 25° C. and has a hydroxy value ranging from about 30 to about 600; and
(c) optionally, a blowing agent; and
(d) optionally, auxiliary compounds and additives.

2. The polyurethane foam composition according to claim 1, wherein the viscosity of the aromatic polyester polyol compound ranges from about 200 to about 150,000 centipoises at 25° C.

3. The polyurethane foam composition according to claim 1, wherein the acid value of the aromatic polyester polyol compound ranges from about 0.1 mg of KOH/g to about 10 mg of KOH/g.

4. The polyurethane foam made from the composition of claim 1, wherein the aromatic polyester polyol compound has a bio-renewable content of at least 10% by weight based on the total weight of the aromatic polyester polyol.

5. The polyurethane foam composition according to claim 1, wherein the polyurethane foam is applied to a surface of a roofing, wall, pipe, or storage tank assembly.

6. The polyurethane foam composition of claim 1, wherein the aromatic polyester polyol compound has a recycled content of at least 10% by weight based on the total weight of the aromatic polyester polyol.

7. The polyurethane foam composition according to claim 1, wherein the viscosity of the aromatic polyester polyol compound is lower than a corresponding polyol compound made to the same hydroxyl number, aromatic content, and calculated functionality but without the use of Component (iii).

8. The polyurethane foam composition according to claim 1, wherein the aromatic polyester polyol compound comprises an average functionality ranging from about 1.5 to about 3.5, an average hydroxyl number ranging from about 30 to about 600, and an acid number ranging from about 0.1 to about 10, and has a resulting viscosity ranging from 200 to about 50,000 centipoises at about 25° C.

9. The polyurethane foam composition according to claim 1, wherein the esterification reaction conditions comprise reacting the reactive mixture at a temperature ranging from about 50° C. to about 300° C. for a period ranging from about 1 hour to about 24 hours.

10. The polyurethane foam composition according to claim 1, wherein the reactive mixture further comprises (vi) an esterification catalyst compound and wherein the esterification catalyst compound comprises about 0.001 to about 0.2% by weight based on the weight of the reactive mixture.

11. A method of forming a polyurethane foam product comprising:
reacting, in the presence of a blowing agent, a reactive mixture comprising an isocyanate compound and one or more isocyanate reactive compounds wherein at least one of the isocyanate reactive compounds comprises an aromatic polyester polyol compound that is the esterification reaction product of the following components:
(i) an aromatic acid compound;
(ii) an aliphatic diol compound;
(iii) a dialkylol alkanoic acid compound of Formula I: 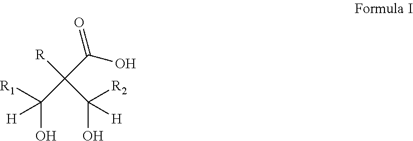
wherein R is hydrogen, C₁ to C₈ alkyl (straight-chain or branched), C₁ to C₈ hydroxyalkyl, C₁ to C₁₂ aromatic, or C₁ to C₁₂ cyclic aliphatic, and wherein R₁, R₂ are each independently hydrogen, C₁ to C₈ alkyl (straight-chain or branched); and
(iv) optionally, a hydrophobic compound, a polyhydroxy compound comprising at least three hydroxyl groups, or combinations thereof; and
wherein the aromatic polyester polyol compound is liquid at 25° C. and has a hydroxy value ranging from about 30 to about 600;

12. The method according to claim 11, wherein the viscosity of the aromatic polyester polyol compound ranges from about 200 to about 150,000 centipoises at 25° C.

13. The method according to claim 11, wherein the acid value of the aromatic polyester polyol compound ranges from about 0.1 mg of KOH/g to about 10 mg of KOH/g.

14. The method according to claim 11, wherein the aromatic polyester polyol compound has a bio-renewable content of at least 10% by weight based on the total weight of the aromatic polyester polyol.

15. The method according to claim 11, wherein the aromatic polyester polyol compound has a recycled content of at least 10% by weight based on the total weight of the aromatic polyester polyol.

16. The method according to claim 11, wherein the viscosity of the aromatic polyester polyol compound is lower than a corresponding polyol compound made to the same hydroxy number, aromatic content, and calculated functionality but without the use of Component (iii).

17. The method according to claim 11, wherein the aromatic polyester polyol compound comprises an average functionality ranging from about 1.5 to about 3.5, an average hydroxyl number ranging from about 30 to about 600, and an acid number ranging from about 0.1 to about 10, and has a resulting viscosity ranging from 200 to about 50,000 centipoises at about 25° C.

18. The method according to claim 12, wherein the esterification reaction conditions comprise reacting the reactive mixture at a temperature ranging from about 50° C. to about 300° C. for a period ranging from about 1 hour to about 24 hours.

19. The method according to claim 12, wherein the reactive mixture further comprises (vi) an esterification catalyst compound and wherein the esterification catalyst compound comprises about 0.001 to about 0.2% by weight based on the weight of the reactive mixture.

20. The method according to claim 12, wherein the method further comprises applying the reactive mixture to a surface of a roofing, wall, pipe, or storage tank assembly.
